(19) United States
(12) Patent Application Publication
(10) Pub. No.: US 2002/0067329 A1
(43) Pub. Date: Jun. 6, 2002

(54) Liquid-crystal device and a method of driving the same

(75) Inventors: Yasuo Toko, Meguro-ku (JP); Yoshihisa Iwamoto, Meguro-ku (JP); Kazuki Takeshima, Meguro-ku (JP)

Correspondence Address: FRISHAUF, HOLTZ, GOODMAN,, LANGER & CHICK, P.C., 25th Floor, 767 Third Avenue, New York, NY, 10017-2023, US

(73) Assignee: Stanley Electric Co., Ltd., Tokyo (JP)

(21) Appl. No.: 09/977,599

(22) Filed: Oct. 15, 2001

(30) Foreign Application Priority Data
Oct. 16, 2000 (JP) 2000-315567

(51) Int. Cl. G09G 3/36

(52) U.S. Cl. 345/94

(57) ABSTRACT

A method of driving a liquid-crystal device having a gap of 15 μm to 200 μm between transparent substrates, a first electrode and a second electrode formed on opposing surfaces of the substrates, and liquid crystal filled in the gap between the substrates, the liquid crystal changing direction by applying a driving voltage, includes the steps of (a) applying a first waveform to obtain a first optical characteristic of the liquid crystal and (b) applying a second waveform to obtain a second optical characteristic of the liquid crystal other than the first optical characteristic, the second waveform having an effective voltage lower by 10 V to 500 V than an effective voltage of the first waveform.

This application is based on Japanese Patent Application 2000-315567 filed on October 16th, all entire content of which is incorporated in this application by reference.

### BACKGROUND OF THE INVENTION

1. Field of the Invention

The present invention relates to a liquid-crystal device and a method of driving the same, and in particular, to a liquid-crystal technique capable of remarkably changing a direction of alignment of molecules of liquid crystal at a high speed.

2. Description of the Related Art

Liquid crystal has a refractive index of which the value changes in a director direction and a direction vertical or orthogonal thereto. For example, the director direction of liquid crystal can be controlled by changing a voltage applied thereto, and optical characteristics such as the refractive index can be changed by applying a voltage thereto. By using the functional properties of liquid crystal, it is possible to produce optical modulation devices such as a liquid-crystal lens, a liquid-crystal shutter, and a liquid-crystal prism.

Emission light which has passed a liquid-crystal layer and which is emitted therefrom has a phase varying in accordance with a value of a voltage applied to the liquid-crystal layer. Using liquid crystal, there can be produced a phase modulation device of which a phase of the emission light can be changed by the voltage applied thereto.

When the voltage applied to the optical modulation device and the phase modulation device is changed at a high speed, it is desirable that the optical characteristics such as a refractive index and a phase of the emission light are also changed satisfactorily following the change of the applied voltage. Additionally, in the optical modulation device and the phase modulation device, it is favorable that a relatively large change occurs in the refractive index and the phase change in response to the change in the applied voltage.

In general, when the cell thickness of a liquid-crystal cell is reduced, the switching speed of the liquid crystal can be increased. However, the changes respectively of the refractive index and the phase become smaller. For example, in an liquid-crystal cell produced using two substrates opposing to each other and nematic liquid crystal interposed between the substrates, when the cell thickness is about 2 micrometers (um) or less, there is obtained a high switching speed of 2 milliseconds (ms) or less. However, the phase shift is insufficient. When the cell thickness is increased, the phase shift becomes greater. For example, when the cell thickness is about 5 μm, there is obtained a large phase shift to some extent as compared with the case of the smaller cell thickness. However, there can be obtained only a low switching speed 10 ms or more.

### SUMMARY OF THE INVENTION

It is therefore an object of the present invention to provide a liquid-crystal device technique capable of achieving a high-speed switching operation while keeping a large change in the refractive index and a large phase shift.

According to one aspect of the present invention, there is provided a method of driving a liquid-crystal device comprising a transparent first substrate and a transparent second substrate disposed opposing said first substrate with a distance of 15 μm to 200 μm therebetween, a first electrode and a second electrode formed respectively on opposing surfaces respectively of said first and second substrates, and liquid crystal interposed between said first and second substrates, said liquid crystal having a direction of alignment which is changed by applying a driving voltage having a predetermined waveform between said first and second electrodes to thereby change optical characteristics of the liquid crystal. The method comprises the steps of (a) applying a driving voltage having a first waveform to obtain a first optical characteristic of said liquid crystal between said first and second electrodes; and (b) applying a driving voltage having a second waveform to obtain a second optical characteristic of said liquid crystal other than the first optical characteristic of said liquid crystal between said first and second electrodes, said driving voltage having said second waveform having an effective voltage lower by 10 V to 500 V than an effective voltage of said driving voltage having said first waveform.

According to another aspect of the present invention, there is provided a method of driving a liquid-crystal device comprising a transparent first substrate and a transparent second substrate disposed opposing said first substrate with a distance of 15 μm to 200 μm therebetween, a first electrode and a second electrode formed respectively on opposing surfaces respectively of said first and second substrates, and liquid crystal interposed between said first and second substrates, said liquid crystal having a direction of alignment which is changed by applying a driving voltage having a predetermined waveform between said first and second electrodes to thereby change optical characteristics of the liquid crystal. The method comprises the steps of (A) applying a driving voltage having a first waveform to obtain a first optical characteristic of said liquid crystal between said first and second electrodes; and (B) applying a driving voltage having a second waveform to obtain a second optical characteristic of said liquid crystal other than the first optical characteristic of said liquid crystal between said first and second electrodes, said driving voltage having said second waveform having an effective voltage higher by 10 V to 500 V than an effective voltage of said driving voltage having said first waveform.

According to still another aspect of the present invention, there is provided a liquid-crystal device, comprising a transparent first substrate and a transparent second substrate disposed opposing said first substrate with a distance of 15 μm to 200 μm therebetween; a first electrode and a second electrode formed respectively on opposing surfaces respectively of said first and second substrates; a layer of liquid crystal interposed between said first and second substrates; and a driving voltage generating circuit capable of applying, between said first electrode and said second electrode, a first voltage and a second voltage lower than said first voltage, an effective voltage difference between said first and second voltages ranging from 10 V to 500 V.

By using the liquid-crystal device technique, it is possible to remarkably change the characteristics of liquid crystal at a high speed.

In a liquid-crystal device according to the present invention, a high-speed switching operation and a remarkable change in optical characteristics of liquid crystal are compatible with each other. Performance of optical functional devices and phase modulating devices can be improved.

### BRIEF DESCRIPTION OF THE DRAWINGS

The objects and features of the present invention will become more apparent from the consideration of the following detailed description taken in conjunction with the accompanying drawings in which:

FIGS. 1A and 1B are diagrams schematically showing structure of a liquid-crystal device in an embodiment of the present invention in which FIG. 1A shows a state in which a high voltage (a first voltage) is applied to the device and FIG. 1B shows a state in which a low voltage (a second voltage) is applied to the device;

FIG. 2 is a graph showing a waveform of a voltage to drive a liquid-crystal device in a first embodiment of the present invention;

FIG. 3 is a graph showing a relationship between a phase shift and applied voltage of a liquid-crystal device in an embodiment of the present invention;

FIG. 4 is a graph showing a waveform of a voltage to drive a liquid-crystal device in a second embodiment of the present invention;

FIGS. 5A to 5D are diagrams showing changes of alignment of liquid-crystal molecules, in zones I to IV of FIG. 4, in the liquid-crystal device of the second embodiment;

FIG. 6 is a graph showing a phase shift of the liquid-crystal device of the second embodiment with respect to time;

FIG. 7 is a graph showing a first variation of the waveform of a voltage to drive the liquid-crystal device in the second embodiment; and

FIG. 8 is a graph showing a second variation of the waveform of a voltage to drive the liquid-crystal device in the second embodiment.

### DETAILED DESCRIPTION OF THE EMBODIMENTS

The inventor has detected that it is possible to increase the amount of phase shift and to accelerate the switching speed at the same time by setting the cell thickness of a liquid-crystal device and the amplitude of a voltage for the switching operation respectively to values considerably larger than the values of the prior art.

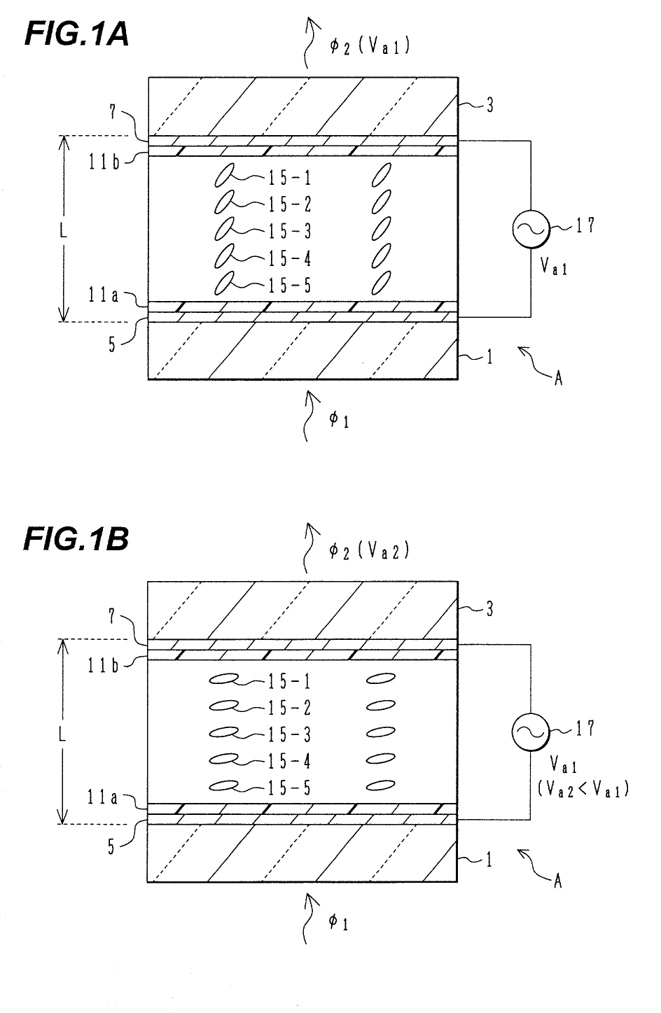

Referring now to FIGS. 1A, 1B, 2, and 3, description will be given of a first embodiment of the present invention. As shown in FIGS. 1A and 1B, a liquid-crystal device A includes two transparent glass substrates 1 and 3 disposed in parallel with each other with a predetermined distance L therebetween, first and second transparent electrodes 5 and 7 formed respectively on inside surfaces of the respective substrates 1 and 3, and tolane liquid-crystal molecules 15 (15-1 to 15-5) interposed between the glass substrates 1 and 3.

Alignment layers 11a and 11b prepared to align the tolane liquid-crystal molecules 15 in an anti-parallel state are formed respectively on the first and second transparent electrodes 5 and 7. Materials for the tolane liquid-crystal molecules 15 are, for example, liquid-crystal materials of bicyclic alkylalkoxy tolane and tricyclic alkyl cyclohexyl alkoxy tolane. The materials have a large birefringence index and low viscosity, for example, the large birefringence index Δn is about 0.25 and the viscosity η is 20 c.p.

In the liquid-crystal device, the cell thickness L between the transparent glass substrates 1 and 3 is set to a large value of 50 μm. The cell thickness L is controlled using a gap control agent (CG agent, not shown) as in ordinary liquid-crystal devices.

The liquid-crystal device A further includes an alternating-current (ac) power source (driving voltage generator) to apply a voltage between the first and second transparent electrodes 5 and 7. The device A has a threshold voltage Vth of about 1.8 volt (V).

In the liquid-crystal device A, the switching operation takes place is switched between a first voltage Va1 and a second voltage Va2 lower than the first voltage Va1.

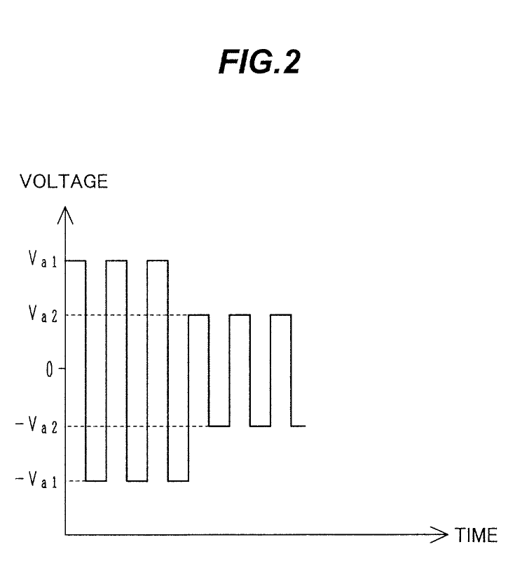

FIG. 2 shows a waveform of an ac voltage used to drive a liquid-crystal device in a first embodiment of the present invention, the ac voltage being applied between a first electrode and a second electrode of the liquid-crystal device. The abscissa represents time and the ordinate represents the voltage. The waveform is a waveform at a falling edge of the voltage signal.

As shown in FIGS. 1A, 1B, and 2, the ac driving voltage is changed from Va1 (e.g., 30 V) to Va2 (e.g., 20 V) at the falling edge. At a rising edge of the signal, it is only necessary to change the ac driving voltage from Va2 (e.g., 20 V) to Val (e.g., 30 V).

Next, operation of the liquid-crystal device A will be described by referring to FIGS. 1A, 1B, and 2.

FIG. 1A shows structure of a liquid-crystal cell in a case, corresponding to former part of FIG. 2, in which a high ac voltage of about 30 V is applied as the first voltage Va1 between the first and second electrodes 5 and 7. In the liquid-crystal device A, the alignment layers are formed such that liquid-crystal molecules are aligned in an anti-parallel state when the voltage is absent between the electrodes 5 and 7 and the longitudinal direction of the tolane liquid-crystal molecules 15 is substantially orthogonal to a direction of a normal of the substrates 1 and 3.

As shown in FIGS. 1A, 1B, and 2, when a high ac voltage (Va1) is applied, the longitudinal direction of the tolane liquid-crystal molecules 15 inclines toward a direction parallel to the direction of the normal of the substrates 1 and 3. Assume that incident light incident to the liquid crystal device A has a phase of Φ1, and emission light from the device A when the voltage Va1 is applied between the electrodes 5 and 7 has a phase of Φ2 (Va1).

As shown in FIGS. 1B and 2, when an ac voltage (Va2; Va2 <Va1) having a lower effective value than Va1 is applied, the longitudinal direction of the tolane liquid-crystal molecules 15 inclines toward a direction orthogonal to the direction of the normal of the substrates 1 and 3. A phase shift ΔΦv of the emission light when the effective value of the applied voltage is changed from Va1 to Va2 is expressed as ΔΦv =Φ2(Va2)−Φ2(Va1).

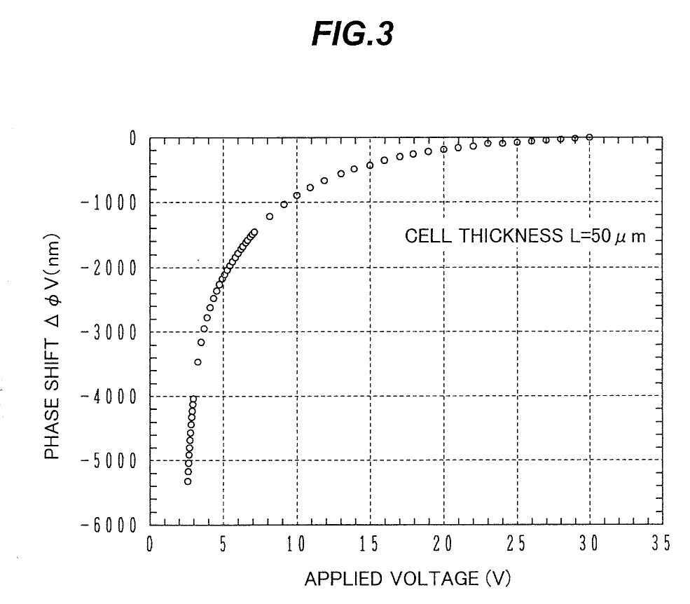

FIG. 3 shows a relationship between the phase shift ΔΦv of the emission light (the ordinate) and the voltage between the first and second transparent electrodes 5 and 7 (the abscissa). The phase shift ΔΦv is investigated between the phase of the emission light when the effective value of the applied voltage is set to a first voltage, for example, 30 V (defined as a reference voltage) and the phase of the emission light when the applied voltage is set to a second voltage less than the first voltage.

When the applied voltage is changed from 30 V (the first voltage) to 20 V (the second voltage), that is, when the voltage amplitude is 10 V, the phase shift is about 200 nm. When the applied voltage is changed from 30 V to 15 V, that is, when the voltage amplitude is 15 V, the phase shift is about 400 nm. When the applied voltage is changed from 30 V to 12 V, that is, when the voltage amplitude is 18 V, the phase shift is about 600 nm.

TABLE 1

| Δφv(nm) | Rise time (ms) | Fall time (ms) |
|---|---|---|
| 200 | 1.75 | 4.77 |
| 400 | 2.57 | 6.61 |
| 600 | 2.42 | 9.93 |

Table 1 shows a relationship between the phase shift ΔΦv, the rise time (required for the actual phase shift when the applied voltage is increased), and the fall time (required to achieve a predetermined phase shift when the applied voltage is decreased).

When the phase shift ΔΦv is 200 nm (the voltage amplitude is 10 V), the rise time is 1.75 ms and the fall time is 4.77 ms. When the phase shift ΔΦv is 400 nm (the voltage amplitude is 15 V), the rise time is 2.57 ms and the fall time is 6.61 ms. When the phase shift ΔΦv is 600 nm (the voltage amplitude is 18 V), the rise time is 2.42 ms and the fall time is 9.93 ms.

According to Table 1, in a case in which the liquid-crystal device of the embodiment is used, when the difference (amplitude) between the first and second voltages ranges from 10 V to 18 V, a considerably high switching speed of 10 ms or less is confirmed for the rise time and the fall time.

In the embodiment, the cell thickness is 50 μm. However, as a result of theoretical and experimental investigation, it has been detected that in the production of liquid-crystal devices, the cell thickness (the distance between the substrates) favorably ranges from 5 μm to 200 μm, more favorably from 15 μm to 200 μm. Moreover, the amplitude of the applied voltage (the effective difference between the first and second voltages) favorably ranges from 5 V to 1 kV, and an ac power source is favorable for this operation. The amplitude of the applied voltage more favorably ranges from 10 V to 500 V. The effective difference between the first and second voltages need only be defined as a difference obtained by dividing the total of products between each voltage and associated one of the sub-periods of a predetermined period by the predetermined period. Therefore, the effective difference between the first and second voltages can be obtained even when the first and second voltages are variable.

According to Table 1, a high-speed switching can be achieved by the liquid-crystal device. However, when the applied voltage is lowered, the period of time required for the fall of the phase is slightly long, namely, the switching speed is slightly slow.

As a result of experiments, it has been detected that the fall time is reduced by adding optically setting or photo-setting monomer in the tolane liquid crystal 15. As the photo-setting monomer, ULC-001 (DIC) is added at 6 weight percent (wt%) to the liquid crystal 15. ULC-001 (DIC) is a monomer having a liquid-crystal characteristic (T_{Ni}=46° C., Δn=0.152) and polymerizes when radiated with a ultra-violet (UV) ray. Moreover, an optical reaction or photo-reaction initiator is at 1 wt% added thereto.

After the liquid crystal cell is prepared using a liquid crystal including the photo-setting monomer, the liquid crystal cell is radiated with UV light without a voltage applied thereto. The photo-setting monomer polymerizes and hence the liquid crystal hardens.

Also in the liquid crystal device prepared as above, the relationship between the applied voltage and the phase shift is almost the same as that shown in FIG. 3. However, the rise time and the fall time to obtain the predetermined phase shift vary as follows.

TABLE 2

| Δφv(nm) | Rise time (ms) | Fall time (ms) |
|---|---|---|
| 200 | 2.69 | 4.25 |
| 400 | 2.75 | 6.40 |
| 600 | 3.07 | 8.83 |

Table 2 shows a relationship between the phase shift ΔΦv, the rise time, and the fall time.

When the phase shift ΔΦv is about 200 nm (the voltage amplitude is 10 V), the rise time is 2.69 ms and the fall time is 4.25 ms. When the phase shift ΔΦv is about 400 nm (the voltage amplitude is 15 V), the rise time is 2.75 ms and the fall time is 6.40 ms. When the phase shift ΔΦv is about 600 nm (the voltage amplitude is 18 V), the rise time is 3.07 ms and the fall time is 8.83 ms.

According to the results shown in Table 2, it is known that when the photo-setting monomer mixed with the liquid crystal polymerizes, and the fall time to obtain the predetermined phase shift can be reduced.

When the photo-setting monomer is mixed at 4 wt% or less with the liquid crystal, the fall time is almost kept unchanged in the liquid crystal with the photo-setting monomer and the liquid crystal without the photo-setting monomer. When the photo-setting monomer is mixed at more than 8 wt% with the liquid crystal, the phase shift is minimized. Therefore, the value of the photo-setting monomer added to the liquid crystal favorably ranges from 4 wt% to 8 wt%. The favorable value of the photo-setting monomer varies depending on conditions such as materials.

Details of the reasons why the fall time of the liquid crystal device improves when the photo-setting monomer is added to the liquid crystal are unknown. The inventor assumes the reason as below. When the polymerization takes place in the liquid crystal, there is formed a polymer network in which the state of alignment of molecules of the liquid crystal reflects. Therefore, not only in the neighborhood of the boundary plane, but also in the bulk of the liquid crystal, there appears force to restore the state of alignment of the liquid-crystal molecules to the state thereof before the voltage is applied thereto. As a result, the fall time is minimized.

In the polymerization of the photo-setting monomer, a voltage may be beforehand applied to the liquid crystal to form a polymer network in which the state of liquid-crystal molecules risen or driven by the voltage reflects. In this case, the state of the molecules is assumed as a state of alignment thereof when the voltage is off. In the polymerization by light radiation, there may be used, for example, a photo mask to form liquid-crystal regions respectively having different degrees of polymerization. The fall time and the state of alignment of molecules, namely, the refractive index of the liquid crystal can be changed between the respective liquid-crystal regions.

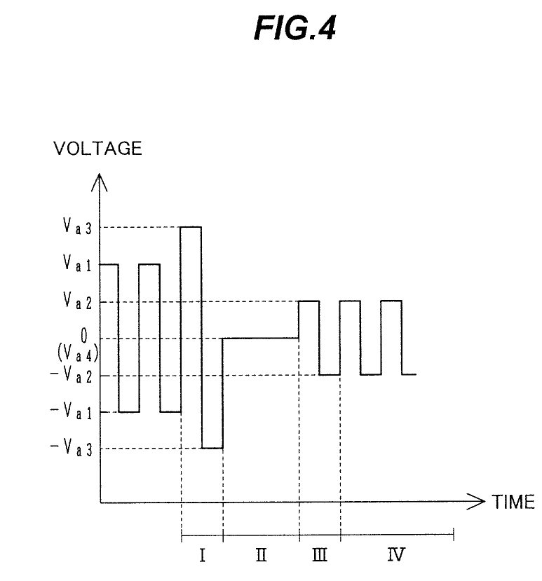

Referring next to FIGS. 4 to 6, description will be given of a method of driving a liquid crystal device in a second embodiment of the present invention. The liquid crystal device is almost the same in structure as that of the first embodiment (FIGS. 1A and 1B).

FIG. 4 shows a waveform of an ac voltage applied between the first and second electrodes of the liquid crystal device. The abscissa and the ordinates respectively represent the time and the voltage. FIG. 4 shows a waveform of the voltage at the falling phase.

In the first embodiment shown in FIG. 2, the driving ac voltage is change from Va1 (e.g., 30 V) to Va2 (e.g., 20 V) in the falling phase only therebetween. In contrast therewith, in the example of FIG. 4, a third voltage Va3 (zone 1) higher than the first voltage Va1 (e.g., 30 V) is applied between the electrodes in the state that the first voltage Va1 has been already applied. The applied voltage Va3 is expressed as Va1×N (N ranges from 1.5 to 2.0) and is, for example, 50 V.

Next, the applied voltage is lowered down to a fourth voltage Va4. The fourth voltage Va4 is, for example, 0 V (zone 11). The fourth voltage Va4 is not necessary to be 0V. The fourth voltage Va4 can take any predetermined value which is lower than the second voltage Va2. Thereafter, the second voltage Va2 (e.g., 20 V) is applied. A zone in which the second voltage Va2 is being applied is indicated as zone III and a subsequent zone in which the second voltage Va2 is continuously being applied is indicated as zone IV.

TABLE 3

| Δφv(nm) | Rise time (ms) | Fall time (ms) |
|---|---|---|
| 200 | 1.75 | 1.82 |
| 400 | 2.57 | 1.98 |
| 600 | 2.42 | 2.25 |

Table 3 shows a relationship between the phase shift ΔΦv and the fall time. In the rising phase, since the liquid crystal device is driving in almost the same way as for the first embodiment (a low voltage is changed directly to a high voltage), the values of the rise time are the same as those of Table 1.

When the phase shift ΔΦv is 200 nm (the voltage amplitude is 10 V), the fall time is 1.82 ms. When the phase shift ΔΦv is 400 nm (the voltage amplitude is 15 V), the fall time is 1.98 ms. When the phase shift ΔΦv is 600 nm (the voltage amplitude is 18 V), the fall time is 2.25 ms. The fall time is remarkably reduced when compared with the driving method of the first embodiment.

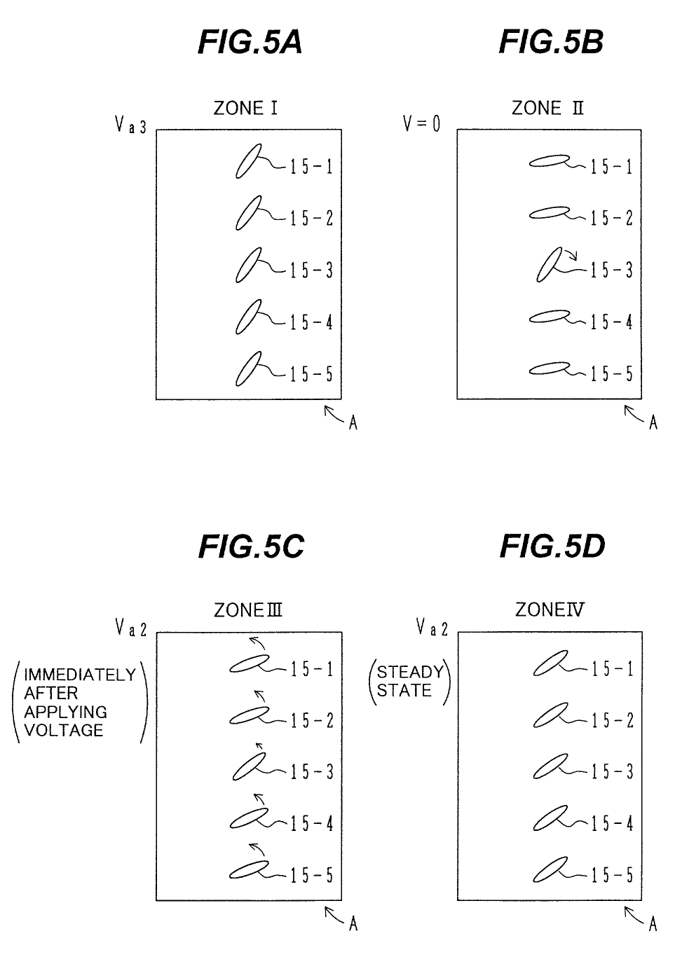

Although the reason of the reduction of the fall time has not been clarified at present, the fall time reduction can be interpreted as follows. Referring now to FIGS. 5A to 5D, a conjectured mechanism of reducing the fall time will be described.

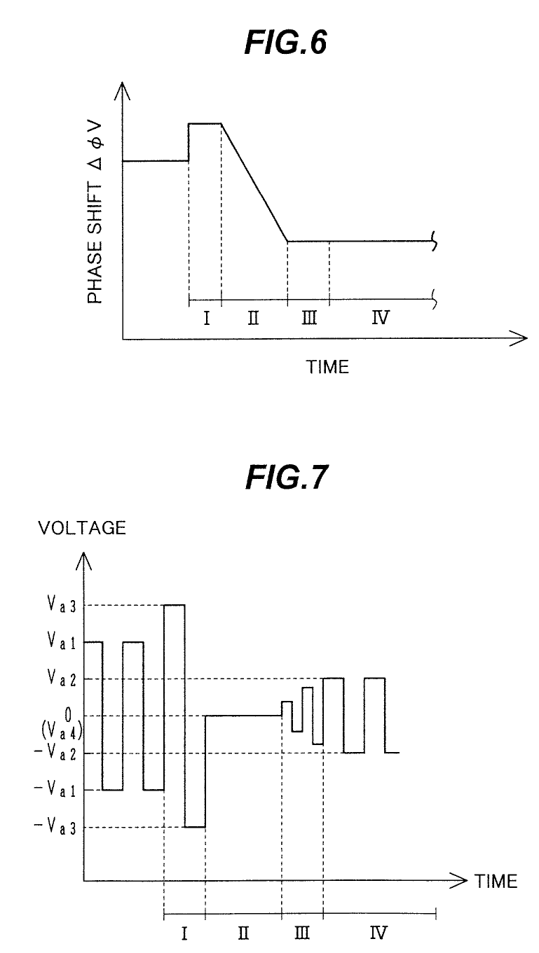

FIGS. 5A to 5D schematically show states of alignment of molecules of the liquid-crystal in the respective zones when the driving voltage waveforms respectively of zones I to IV of FIG. 4 are applied thereto. FIG. 6 shows a change of the phase shift ΔΦv with respect to time. In FIG. 6, the phase shift is shown in comparison with a state in which the voltage is not applied is assumed as a reference state.

First, when the third voltage Va3 higher than the first voltage Va1 is applied (zone I of FIG. 4), molecules of the liquid crystal aligns in a direction similar to the vertical direction as shown in FIG. 5A. That is, the liquid-crystal molecules in the bulk such as a molecule 15-3 and the liquid-crystal molecules on the respective boundaries between the liquid crystal and the respective substrates 15-1 and 15-5 align in a direction substantially parallel to the direction of the normal of the substrate surfaces (vertical direction). A large phase shift takes place as shown in zone I of FIG. 6.

Subsequently, when the fourth voltage Va4 (e.g., 0 V) lower than the second voltage Va2 is applied (zone II), the liquid-crystal molecules start aligning in a horizontal direction as shown in FIG. 5B. However, in this state in which the fourth voltage Va4 is applied, while the liquid-crystal molecules near the respective boundaries between the liquid crystal and the respective substrates 15-1 and 15-5 rapidly re-align in the horizontal direction, the liquid-crystal molecules in the bulk, e.g., the molecule 15-3 have a slow re-aligning speed and hence there exists a state in which these molecules are still in a direction similar to the vertical direction. As above, the alignment direction of the liquid-crystal molecules varies in the direction of the cell thickness. However, as shown in Table 3, the period of time required to obtain the same phase shift as the predetermined phase shift ΔΦv=Φ2(Va2)−Φ2(Va1) is remarkably reduced as compared with the case of the liquid crystal device described in conjunction with the first embodiment.

At the point of time when the required phase shift ΔΦv is obtained, a voltage, for example, the second voltage Va2 is applied between the electrodes. In this case, it is only necessary to apply the voltage (Va2) used in the first embodiment.

As shown in FIG. 5C, when the voltage Va2 is applied, the liquid-crystal molecule 15 starts inclining toward the vertical direction. However, the liquid-crystal molecules near the respective boundaries between the liquid crystal and the respective substrates 15-1 and 15-5 incline toward the vertical direction higher than the liquid-crystal molecule 15-3 in the bulk. When the voltage Va2 is continuously applied, the liquid-crystal molecules near the respective boundaries 15-1 and 15-5 and the liquid-crystal molecule 15-3 in the bulk align substantially in one direction with a fixed phase shift kept retained (zone IV of FIG. 6). As shown in FIG. 5D, the liquid-crystal molecules are kept uniformly aligned in a stable state. As shown in zones III and IV of FIG. 6, the phase shift is also kept fixed.

As above, in the voltage falling phase, a voltage (the third voltage) higher than the first voltage is first applied, and then the voltage is lowered down to the fourth voltage. Thereafter, a predetermined second voltage lower than the first voltage is applied. Resultantly, a desired phase shift can be obtained in a shorter period when compared with the case in which the liquid crystal device is switched between the first and second voltages without intervention of the third and fourth voltages. The alignment direction of the liquid crystal molecules vary between positions in the direction of the thickness of the liquid crystal. However, the optical characteristic of the liquid crystal device such as a phase shift reflects a so-called average alignment direction of the molecules in the cell. Even when the cell has a large cell thickness, the alignment of liquid-crystal molecules in the vicinity of the substrates changes at a relatively high speed. These liquid-crystal molecules near the substrates contribute to a high-speed change in the optical characteristics of the liquid crystal device.

Referring to FIG. 7, description will now be given of a first variation of the method of driving the liquid crystal device of the second embodiment. FIG. 7 shows a waveform of a driving voltage substantially equal to that of FIG. 4. The waveform of the driving voltage of FIG. 7 differs from that of FIG. 4 in that in zone III from when the voltage is turned off (the fourth voltage) to when a voltage (the second voltage) is applied again (zone IV), the applied voltage is gradually increased toward the second voltage Va2.

In the operation using the voltage waveform of FIG. 4, since the waveform of zone III is applied, the phase shift is possibly increased to a value higher than the desired value for the following reasons. The liquid-crystal molecules in the bulk react slowly and have not the desired inclination yet. Therefore, until the liquid-crystal molecules in the bulk are inclined to the desired state, the applied voltage is controlled as shown in zone III of FIG. 7. By gradually increasing the applied voltage, during the period in which the alignment direction of the liquid-crystal molecules in the bulk is completely changed, the applied voltage is controlled such that the phase shift ΔΦv of the overall liquid crystal device is fixed. In the control operation, the direction of inclination of liquid-crystal molecules in the vicinity of the boundary planes in which the inclination takes place at a high speed is controlled by the applied voltage.

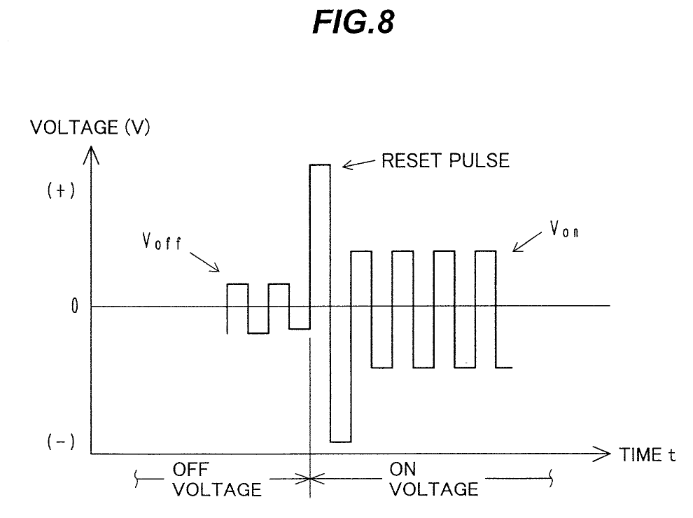

Referring to FIG. 8, description will now be given of a second variation of the method of driving the liquid crystal device of the second embodiment. The second variation has a feature in the waveform of the voltage applied to change the liquid crystal from an off state to an on state.

For the response time when the liquid crystal is switched from the off state to the on state (in the rising phase), the step to apply the high voltage is most dominant. In consideration of this fact, as shown in FIG. 8, when switching the liquid crystal from the off state applied with a voltage for the off state (Voff) to the on state, a pulsated voltage (“reset pulse”) higher than a voltage (Von) to be continuously applied in the on state is applied. The value of the reset pulse voltage is favorably about 1.5 times to about 2 times the value of Von. By applying the reset pulse, the period of time required for the rising operation, the rise time can be further reduced to obtain a phase shift. When the reset pulse is 1.5 times of Von, in order to obtain phase shift of 600nm, it was confirmed that required rise time is 2ms or less, whereas required rise time is 2.42ms when no reset pulse is included.

When the reset pulse voltage is three times or more of Von, the relaxation time becomes too long and the response time cannot be reduced.

Description has been given of embodiments of the present invention. It is to be understood that various modifications, improvements, and combinations are possible for those skilled in the art.

For example, the materials of the liquid crystal favorably has, not particularly limited to, a large birefringence index (Δn) and a small value of viscosity.

The alignment direction is the vertical alignment (for liquid crystal having a negative value of Δε), the hybrid alignment, the twist alignment, or the bent alignment.

Changes in the optical characteristics of the liquid-crystal devices in the embodiments have been described by paying attention primarily to the phase shift of the emission light. However, the present invention is applicable also when other optical characteristics such as the refractive index and the light emission rate are changed.

The liquid-crystal devices in the embodiments have quite simply structure. That is, using such simple structure, a large phase shift can be obtained through a high-speed switching.

The liquid-crystal devices in the embodiments can be applied to a liquid-crystal lens, a liquid-crystal shutter, a liquid-crystal prism, an optical phase modulation device, a phase modulation device for millimeter waves and microwaves, or the like.

In the phase modulation devices for millimeter waves and microwaves, the liquid-crystal cell favorably has a large cell thickness to form a micro-strip line. The liquid-crystal devices in the embodiments can be suitably applied to the phase modulation devices for millimeter waves and microwaves.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed are:

1. A method of driving a liquid-crystal device comprising a transparent first substrate and a transparent second substrate disposed opposing said first substrate with a distance of 15 μm to 200 μm therebetween, a first electrode and a second electrode formed respectively on opposing surfaces respectively of said first and second substrates, and liquid crystal interposed between said first and second substrates, said liquid crystal having a direction of alignment which is changed by applying a driving voltage having a predetermined waveform between said first and second electrodes to thereby change optical characteristics of the liquid crystal, said method comprising the steps of:
(a) applying a driving voltage having a first waveform to obtain a first optical characteristic of said liquid crystal between said first and second electrodes; and
(b) applying a driving voltage having a second waveform to obtain a second optical characteristic of said liquid crystal other than the first optical characteristic of said liquid crystal between said first and second electrodes, said driving voltage having said second waveform having an effective voltage lower by 10 V to 500 V than an effective voltage of said driving voltage having said first waveform.

2. A liquid-crystal device driving method according to claim 1, wherein:
said step (a) includes the step (a-1) of applying a first voltage to obtain a first optical characteristic of said liquid crystal between said first and second electrodes; and
said step (b) includes the step (b-1) of applying a second voltage to obtain a second optical characteristic of said liquid crystal other than the first optical characteristic of said liquid crystal, between said first and second electrodes, said second voltage being lower by 10 V to 500 V than said first voltage.

3. A liquid-crystal device driving method according to claim 1, wherein said step (a) includes further comprising the step (a-2) of applying a third voltage higher than said first voltage and then applying a fourth voltage lower than said second voltage and thereby accelerating to change to said second optical characteristic.

4. A liquid-crystal device driving method according to claim 1, wherein said step (a) further comprising the step (a-3) of applying a third voltage higher than said first voltage, applying a fourth voltage lower than said second voltage, gradually increasing said fourth voltage toward said second voltage, and thereby accelerating to change to said second optical characteristic.

5. A liquid-crystal device driving method according to claim 1, wherein each of said steps (a) and (b) include the step of applying an alternating-current (ac) voltage.

6. A method of driving a liquid-crystal device comprising a transparent first substrate and a transparent second substrate disposed opposing said first substrate with a distance of 15 μm to 200 μm therebetween, a first electrode and a second electrode formed respectively on opposing surfaces respectively of said first and second substrates, and liquid crystal interposed between said first and second substrates, said liquid crystal having a direction of alignment which is changed by applying a driving voltage having a predetermined waveform between said first and second electrodes to thereby change optical characteristics of the liquid crystal, said method comprising the steps of:
(A) applying a driving voltage having a first waveform to obtain a first optical characteristic of said liquid crystal between said first and second electrodes; and
(B) applying a driving voltage having a second waveform to obtain a second optical characteristic of said liquid crystal other than the first optical characteristic of said liquid crystal between said first and second electrodes, said driving voltage having said second waveform having an effective voltage higher by 10 V to 500 V than an effective voltage of said driving voltage having said first waveform.

7. A liquid-crystal device driving method according to claim 6, further comprising the step (C), between said step (A) and said step (B), of applying at least one pulse voltage having an effective voltage higher than said second voltage.

8. A liquid-crystal device driving method according to claim 7, wherein said pulse voltage has an effective voltage which is about 1.5 times to about 2.0 times of said second voltage.

9. A liquid-crystal device driving method according to claim 6, wherein
said step (A) includes the step (A-1) of applying a first voltage to obtain a first optical characteristic of said liquid crystal between said first and second electrodes; and
said step (B) includes the step (B-1) of applying a second voltage to obtain a second optical characteristic of said liquid crystal other than the first optical characteristic of said liquid crystal between said first and second electrodes, said second voltage being lower by 10 V to 500 V than said first voltage.

10. A liquid-crystal device driving method according to claim 6, wherein each of said steps (A) and (B) include the step of applying an alternating-current (ac) voltage.

11. A liquid-crystal device, comprising:
a transparent first substrate and a transparent second substrate disposed opposing said first substrate with a distance of 15 μm to 200 μm therebetween;
a first electrode and a second electrode formed respectively on opposing surfaces respectively of said first and second substrates;
a layer of liquid crystal interposed between said first and second substrates; and
a driving voltage generating circuit capable of applying, between said first electrode and said second electrode, a first voltage and a second voltage lower than said first voltage, an effective voltage difference between said first and second voltages ranging from 10 V to 500 V.

12. A liquid-crystal device according to claim 11, further comprising an ac power source.

13. A liquid-crystal device according to claim 11, wherein said liquid-crystal layer including molecules of a tolane liquid-crystal.

14. A liquid-crystal device according to claim 11, wherein said liquid-crystal layer including a polymer formed by polymerizing a photo-setting monomer.

15. A liquid-crystal device according to claim 14, wherein said polymer is formed through polymerization of said photo-setting monomer by applying a voltage to said liquid-crystal layer.

16. A liquid-crystal device according to claim 14, wherein said polymer forms a network.

17. A liquid-crystal device according to claim 14, wherein said liquid-crystal layer includes regions respectively having different degrees of polymerization.

18. A liquid-crystal device according to claim 11, wherein optical characteristics of said liquid crystal are changed according to a change of a direction of alignment of said liquid crystal between a state in which said first voltage is applied to the liquid crystal and a state in which said second voltage is applied thereto.
